(19) United States
(12) Patent Application Publication
(10) Pub. No.: US 2013/0066541 A1
(43) Pub. Date: Mar. 14, 2013

(54) STARTER DEVICE, INTERFACE DEVICE, AND METHOD FOR OPERATING A SYSTEM OF A STARTER DEVICE

(71) Applicants: Harald Schueler, Backnang (DE); Markus Roessle, Stuttgart (DE); Sven Hartmann, Stuttgart (DE)

(72) Inventors: Harald Schueler, Backnang (DE); Markus Roessle, Stuttgart (DE); Sven Hartmann, Stuttgart (DE)

(21) Appl. No.: 13/637,863

(22) PCT Filed: Mar. 16, 2011
(86) PCT No.: PCT/EP11/53923

§ 371 Date: Nov. 30, 2012

(30) Foreign Application Priority Data
Mar. 30, 2010 (DE) 102010003482.7
Dec. 1, 2010 (DE) 102010062238.9

(51) Int. Cl. F02N 11/08

(52) U.S. Cl. 701/113

(57) ABSTRACT

A method is described for operating a system, in particular a starter device for starting an internal combustion engine of a motor vehicle, in the system a real-time signal for achieving an activation state of an actuating device being transmitted from a controller to the actuating device via a real-time communication device with the aid of real-time interfaces. To increase flexible control of the system, for example for a start-stop operation of a vehicle, using a simple configuration, the actuating device and the controller each have a data interface via which data information is transmitted with the aid of a data communication device.

### FIELD OF THE INVENTION

The present invention relates to a method for operating a system, in particular having a starter device for starting an internal combustion engine of a motor vehicle, in the system a real-time signal for achieving an activation state of an actuating device being transmitted from a controller to the actuating device via a real-time communication means with the aid of real-time interfaces. Moreover, the present invention relates to an interface device for a controller or an actuating device, which in each case is provided in particular for a starter device of a motor vehicle for starting an internal combustion engine, the interface device having a real-time interface which is designed for transmitting a real-time signal from the controller to the actuating device via a real-time communication device for achieving an activation state of the actuating device. Moreover, the present invention relates to a starter device for an internal combustion engine, in particular for a motor vehicle, having a system which includes a controller and an actuating device which are each coupled with the aid of real-time interfaces via a real-time communication means for transmitting a real-time signal, the real-time signal for achieving an activation state of the actuating device being transmittable from the controller to the actuating device. Furthermore, the present invention relates to a computer program product.

### BACKGROUND INFORMATION

A conventional starter device for an internal combustion engine in a motor vehicle for starting the internal combustion engine a starter motor is coupled to the internal combustion engine in that a starter pinion is meshed with an annular gear of the internal combustion engine with the aid of a meshing relay, and the starter motor is energized, with the aid of a switching relay, for cranking the internal combustion engine.

German Patent Application No. DE 10 2009 028 294 describes a starter device for starting an internal combustion engine, in which a separate driver unit is controlled via a hardware interface with the aid of an engine control unit, the hardware interface in turn controlling a meshing relay, a starting current relay, and a main current relay.

### SUMMARY

An object of the present invention is to refine a method for operating the system, an interface device, a starter device, and a computer program product in such a way that flexible control of the system, for example for a start-stop operation of a vehicle, is increased using a simple configuration.

One aspect of the present invention is that command information which determines the activation state or a change in the activation state is transmitted together with the real-time signal. Thus, on the one hand it is preferred that the command information describes a certain activation state, in that an intentional control for all consumers is transmitted as command information. A certain activation state may thus be achieved, regardless of a prior activation state. On the other hand, it is also preferred that the command information alternatively or additionally describes a change in the activation state, so that a prior activation state may be taken into account. The prior activation state may be unknown to the controller. A certain electrical consumer, in particular a certain switching device, is preferably controlled in a defined manner, independently of an instantaneous switching state of other consumers, in that the command information includes information for achieving a certain switching state of the consumer in question, and other consumers are controlled in an unchanged manner, uninfluenced by the command information. Thus, the activation as well as the control may be simplified in that the real-time signal is not used to transmit extensive command information for the overall activation state, i.e., a description of all switching states of the overall controllable consumers, for example, but instead to transmit only a reduced volume of information.

An actuating device and a controller each have a data interface via which data information is transmitted with the aid of a data communication means. Accordingly, in accordance with the present invention, an interface device has a data interface for a data communication means via which the controller and the actuating device are coupleable. Moreover, in accordance with the present invention, in a starter device, the controller and the actuating device each have a data interface via which they are coupled to a data communication device.

Thus, the controller and the actuating device are connected via two different interfaces, specifically, via the real-time interface and also via the data interface. With the aid of the real-time signal, the actuating device may be addressed securely, and within the processing time in a reliable manner, by the controller in order to achieve a certain activation state within predefined time periods. With the aid of the additional data interface, information which in particular is extensive and variable in volume may be flexibly transmitted without jeopardizing, or having to meet, a temporal transmission characteristic, in particular the real-time character of the real-time signal.

In addition, diagnostic information may be transmitted from the actuating device to the controller via the data interfaces, for example to query or communicate an instantaneous activation state, thus increasing the operational reliability of the system. Two-way communication may thus be achieved without jeopardizing reliable transmission of the real-time signal.

The data information is preferably transmitted at a slower rate than the real-time signal, in particular also more slowly than an operating cycle of the control process, so that the data interfaces and the data communication device may be cost-effectively implemented with little complexity of components and circuitry. Furthermore, the data information may also be used to transmit additional information for a higher level of transmission security, in particular with the acceptance of longer propagation times.

A propagation time of the real-time signal preferably corresponds to a maximum of one operating cycle of the control process for achieving the activation state, in particular an operating cycle of the actuating device and/or of the controller. Due to the transmission of the real-time signal, a highly accurate control option is thus achieved in the control process for achieving an activation state. The operating cycle may be determined, for example, by a microcomputer of the actuating device and/or of the controller which executes a computer program product, discussed below, and provides a control option which is accurate within milliseconds.

The data communication device as well as the data interfaces may be designed for 1-bit hardware signals or also for pulse width-modulated signals in a cost-effective manner and with little complexity of components. The data communication device is preferably designed as a bus, in particular as a single-wire 1-bit bus (SENT bus), and in particular as a bidirectional bus, for example as a LIN bus. Such communication devices are widely used in conventional motor vehicles, and may be cost-effectively implemented by a simple wired connection, in particular with the aid of a body of the motor vehicle as common ground.

In one preferred specific embodiment, the real-time signal is transmitted at a maximum clock pulse of one millisecond, and/or the data information is transmitted with a propagation time of approximately 100 milliseconds. This allows the data information to be controlled with high temporal resolution and transmitted with immunity to interference.

With the aid of the real-time signal a certain activation state may be switched on or off, in particular for a given control period. In addition, an activation state which subsequently follows according to a certain sequence of activation states may be achieved, or the certain sequence itself may be started, in particular the certain sequence also including a certain time interval of the activation states. Thus, the real-time signal may be transmitted as a mere switch-on, relaying, and/or switch-off signal with little technical complexity in order to achieve a certain activation state with high temporal accuracy, i.e., to switch on or off. The time interval includes at least one control period.

In addition, the certain sequence of activation states may be stored, in particular in the actuating device, and in each case a subsequent activation state which is determined by the sequence may be switched on, i.e., relayed within the sequence, via the real-time signal. Thus, a certain activation state may be switched in a precisely timed manner by a simple, easily implemented real-time signal, having a low volume of information, via which in particular only time information, for example a trigger signal, is transmitted.

Furthermore, the certain time interval may also be stored, in particular in the actuating device, and in particular as a component of the sequence, for example as a list of data pairs composed of an activation state and an associated control period in each case. For achieving a certain activation state for a given control period, only a switch-on signal, and no switch-off signal, is then required as the real-time signal, since the control period of the particular activation state is determined by the time interval. The switch-on signal is preferably used to switch a sequence of activation states determined by the sequence in a precisely timed manner according to the time interval, in that the particular subsequent activation states are automatically switched by the actuating device, and thus in a precisely timed manner by the communication means, regardless of time delays. Complexity of control by the controller may also be reduced in this way.

A plurality of sequences, in particular with or as subsequences, may be implemented, which with the aid of the command information is addressed in a targeted manner by the real-time signal in order to achieve various sequences of activation states. Numerous activation states may thus be achieved in defined sequences, in particular also subsequences, using a few different command information items. The features with regard to the sequence of activation states mentioned previously and below also similarly apply to corresponding subsequences.

To store a sequence in the actuating device in a structurally simple way, a state machine having the certain sequence of activation states may be provided in the actuating device, the state machine preferably being triggered by the real-time signal. Thus, the state machine may be transferred into a subsequent state with little effort by using the real-time signal as a trigger signal.

In addition, the actuating device, in particular the state machine, may be provided with a timer for the certain time interval in order to switch the sequence of activation states automatically, in particular in a precisely timed manner according to the time interval. It is preferred that the state machine is triggered by the timer, and the timer is started by the real-time signal.

It is preferred that prior to the real-time signal with respect to time, the controller transmits data information to the actuating device via the data communication device. More extensive data, for example a parameter, may thus be conveniently exchanged via the data communication device with a high level of transmission security, and preferably at a point in time which is not critical with respect to time, so that the transmitted data information is available at the right time.

The data information preferably determines an activation state, a change in the activation state, a control period, a sequence of activation states, and/or a time interval for the sequence. Data information may thus be transmitted which completely describes a certain activation state or also a change in the activation state, so that a simple switch-on signal or switch-off signal is subsequently transmittable as the real-time signal for achieving the activation state. Additionally or alternatively, the control period may be transmitted as data information so that, for example, the activation state is only switched on by the real-time signal, and is automatically switched off again by the actuating device just after the control period. In this sense, information concerning the sequence of activation states and/or the time interval may also be transmitted in order to automatically switch sequences of activation states by the actuating device, as previously described.

In the system, the actuating device and the controller are preferably implemented as structurally separate units, in particular whereby in a motor vehicle additional structural units, for example control units and/or sensors, for further functions are also coupled to one another in each case via the data communication device with the aid of data interfaces in order to mutually exchange data in any given combinations. Thus, a plurality of structural units may be coupled to the data communication device, although this results in increased data traffic over the data communication device, i.e., delays in transmitting the data packets also increase. However, utilization by the two communication paths becomes correspondingly greater, namely, with the aid of the real-time signal for the temporal accuracy for the control, and the data information for transmitting additional or more extensive information. Due to the structural separation, the controller and the actuating device may be manufactured independently of one another and/or installed at different suitable positions in the motor vehicle.

The actuating device is preferably designed for separate activation of electrical consumers, in particular switching devices. Switching devices may be designed as a switching relay for energizing a starter motor and/or as a meshing relay for coupling the starter motor to the internal combustion engine with the aid of a starter pinion which meshes with an annular gear, whereby in particular the switching relay, the starter motor, the meshing relay, and the starter pinion are an integral part of the starter device. Thus, the starter device may be flexibly used, for example for various actions explained below, the electrical consumers being controlled independently of one another.

In addition, the controller may be integrated into an engine control unit or designed as such, and thus be implemented in a cost-effective and resource-saving manner as a structural unit of the motor vehicle which is present anyway.

In addition, the real-time signal may be used to transmit command information which is pulse width-coded. Such signals may be transmitted with immunity to interference, in particular regardless of voltage fluctuations in a vehicle electrical system of the motor vehicle, it being possible to transmit precise temporal information as a real-time signal via an edge of a pulse. Various activation states may be length-coded using exactly one pulse, or a plurality of pulses may be coded using a number of pulses. For a plurality of pulses, the command information may at the same time also be length-coded, using the number of pulses, in order to increase a volume of information.

The real-time signal may also be used to transmit command information that is voltage-coded so that, for example, various activation states are coded by different electrical voltages of the real-time signal. An additional volume of information may be transmitted with the aid of voltage coding without temporally influencing the real-time signal.

In addition, the real-time signal may be used to transmit command information coded as the algebraic sign of an electrical voltage of the real-time signal, in particular for switching an activation state or a certain consumer on or off. Additional information may thus be transmitted without further time delay, and the real-time signal may be implemented as a switch-on signal as well as a switch-off signal with little complexity of control and circuitry.

According to one specific embodiment, it is preferred that the real-time signal is used to transmit, in parallel, command information that is bit-coded with the aid of the real-time interfaces and a plurality of parallel communication lines of the real-time communication means. Due to a certain number of parallel communication lines, a quantity of different activation states corresponding to this number raised to the power of two may be coded, and in addition, due to a parallel transmission of the real-time signal a volume of information may be increased without additional time delay. Incidentally, the controller, the actuating device, and/or the interface device may also have a corresponding plurality of real-time interfaces which in particular are each provided for exactly one of the parallel communication lines.

It is preferred that the certain plurality corresponds to a number of electrical consumers which are independently controllable by the actuating device. Complicated coding of the real-time signal is thus dispensed with, in that, with the aid of the real-time signal, in each case one consumer is separately controllable in parallel via the parallel communication lines.

The object may also be achieved by a computer program product on a computer-readable data carrier which is loadable into a program memory, using program instructions of a microcomputer, in order to carry out all steps of the example method described above or below, in particular when the computer program product is executed in the controller and/or the actuating device. The computer program product requires little or no additional components and may be easily implemented. The computer program product has the further advantage that it is easily adaptable to individual, specific customer requirements, and an improvement or optimization of individual method steps is possible in a cost-effective manner with little complexity.

It is understood that the features mentioned above and to be explained below are usable not only in the particular stated combination, but also in other combinations.

### BRIEF DESCRIPTION OF THE DRAWINGS

The present invention is explained in greater detail below with reference to the figures.

FIG. 1a shows a circuit diagram of a starter device together with a system.

FIG. 1b shows a circuit diagram of a relay circuit as an alternative to FIG. 1a.

FIG. 2 shows a table containing command information.

FIG. 3 shows a process sequence based on a time-rotational speed characteristic curve diagram and activation states.

FIG. 4 shows another process sequence based on a time-rotational speed characteristic curve diagram and activation states.

FIGS. 5 and FIGS. 6a, 6b in each case show a time-voltage diagram having information coding.

FIG. 7 shows a circuit diagram of one preferred system.

FIG. 8 shows a time-voltage diagram having information coding.

FIG. 9a shows a circuit diagram of one preferred system.

FIG. 9b shows a time-voltage diagram with a variation of activation states over time.

FIG. 10, FIG. 11, FIGS. 12a through 12d each show a circuit diagram of one preferred system.

### DETAILED DESCRIPTION OF EXAMPLE EMBODIMENTS

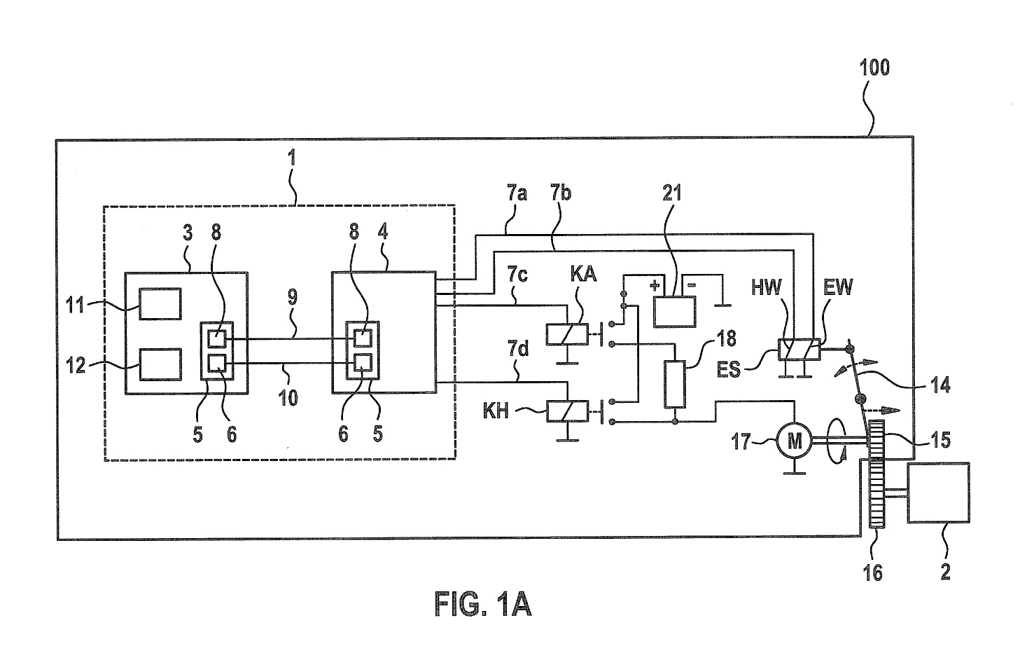

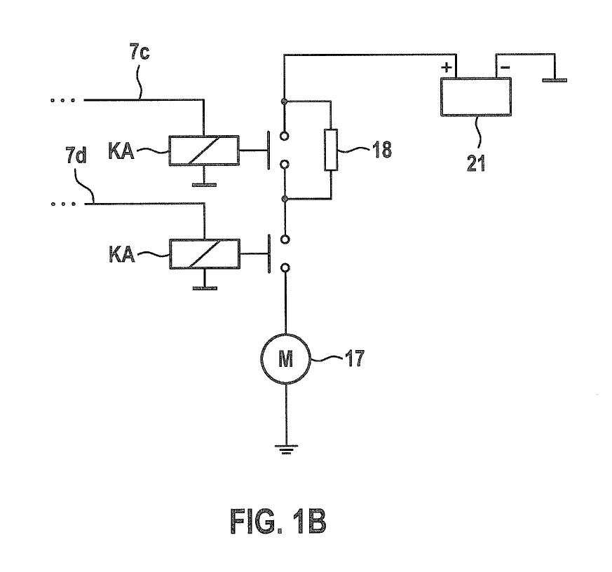

FIG. 1a shows a circuit diagram of a starter device 100 for starting an internal combustion engine 2 of a motor vehicle, having a system 1 which includes a controller 3 and an actuating device 4, each of which has an interface device 5 having a data interface 8 via which the controller and the actuating device are coupled to a data communication device 9. As illustrated in FIG. 12d, data communication device 9 is designed as a bidirectional 1-bit bus.

In addition, interface devices 5 of controller 3 and of actuating device 4 each have a real-time interface 6 for a real-time communication device 10, to which controller 3 and actuating device 4 are additionally coupled. Real-time interfaces 6 and real-time communication device 10 are designed for transmitting a real-time signal S for achieving an activation state Z of actuating device 4, real-time signal S being transmitted from controller 3 to actuating device 4.

Furthermore, controller 3 and actuating device 4 are designed as structurally separate units in the motor vehicle, and in addition, controller 3 is integrated into an engine control unit of the motor vehicle which is already present.

Starter device 100 also includes a starter motor 17 for starting internal combustion engine 2; for coupling starter motor 17 to internal combustion engine 2 via a lever 14, a starter pinion 15 meshes with an annular gear 16 of internal combustion engine 2 with the aid of a meshing relay ES. Starter motor 17 is energizable via a starter relay KA and a holding relay KH, the energization being limited via a starting resistor 18 with the aid of starter relay KA in order to reduce a voltage dip. Starter motor 17 is energized via a battery 21 of the motor vehicle, which also supplies (not illustrated) system 1 and relays KA, KH, ES with electrical power.

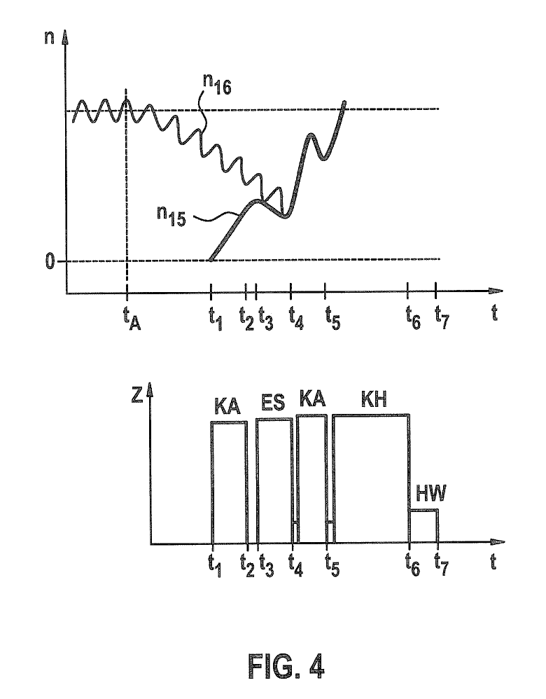

The three relays KA, KH, ES are each separately switchable by actuating device 4 via control lines 7a, 7b, 7c, 7d, meshing relay ES being provided with a duplex winding having two independently controllable windings, namely, a pull-in winding EW and a holding winding HW. As a result, in the present exemplary embodiment a total of 16 different activation states Z are possible. Relays KA, KH, ES may thus be switched independently of one another to allow various actions of the starter device, as illustrated in FIGS. 3 and 4.

It is also possible to arrange relays KA and KH in a serial sequence, as illustrated in FIG. 1b. In that case, relays KA and KH are no longer controlled independently of one another. FIG. 1B shows an alternative circuit configuration of relay KA and KH as a detail of FIG. 1a.

In one alternative exemplary embodiment, it is preferred that each of the three relays KA, KH, ES is provided with a duplex winding, i.e., having two separately controllable windings per relay KA, KH, ES, so that 64 activation states Z are thus possible.

In addition, controller 3 is provided with a microcomputer 11 and a memory 12 in which the method steps mentioned previously and below are carried out. Controller 3 and also actuating device 4 operate in an operating cycle of one millisecond (operating cycles which differ therefrom are also possible if they allow real-time control of the actuating device), whereby data transmission via data interfaces 8 and data communication device 9 on the one hand is comparatively slow at approximately 100 ms, and on the other hand is not precisely predictable due to varying propagation times for different capacity utilizations of data communication device 9. In contrast, a propagation time of real-time signal S via real-time interfaces 6 and real-time communication device 10 is precisely predictable, and in particular is faster than a predefined operating cycle of at the most one millisecond. Thus, real-time signal S may be used to achieve a transmission in real time which is necessary for the process sequence, and which may be used for wear-free or low-wear meshing of a starter pinion with the coasting annular gear of a switched-off internal combustion engine.

According to one preferred exemplary embodiment, interface device 5 or also microcomputer 11 together with interface device 5 is designed as an application-specific integrated circuit, a so-called ASIC, so that system 1 or starter device 100 is manufacturable with little complexity of components.

According to one method for operating system 1, for achieving a certain activation state Z, real-time signal S is transmitted from controller 3 to actuating device 4 via real-time interfaces 6 in order to switch relays KA, KH, ES corresponding to intended activation state Z. With the aid of real-time signal S, high temporal accuracy is achieved during switching of relays KA, KH, ES, since real-time signal S is transmitted from controller 3 to actuating device 4 in real time, i.e., with a propagation time which has no noticeable effect on the process sequence. Thus, time-critical actions may also be carried out with the aid of starter motor 17 and starter pinion 15, as illustrated in FIG. 4. In principle, diagnostic information is transmitted from actuating unit 4 to controller 3 via data communication means 9 and data interfaces 8. In addition, as explained below, data information is preferably transmitted from controller 3 to actuating device 4 via data interfaces 8 and data communication device 9.

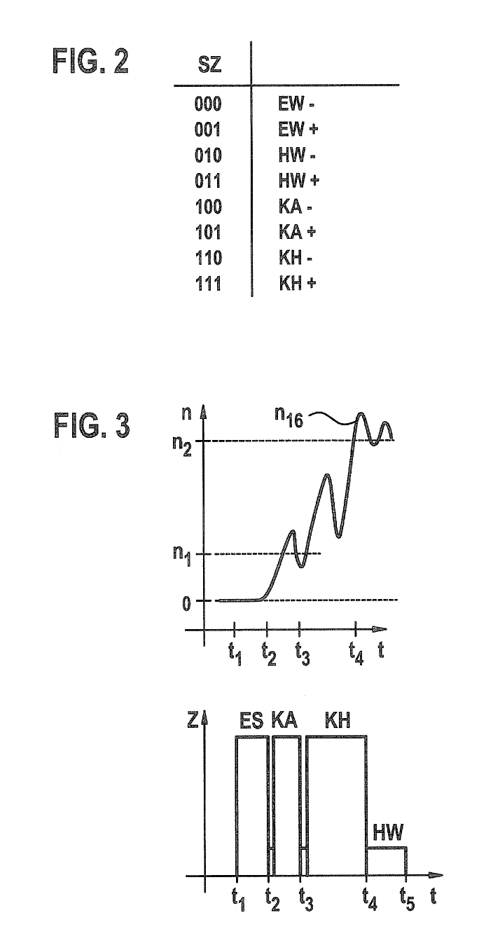

In addition, in one preferred method real-time signal S is used to transmit command information SZ which, as shown in FIG. 2, for example, determines a change in an activation state Z. In another preferred method, real-time signal S is used to transmit command information SZ which completely describes a certain activation state Z, command information SZ thus describing a particular control for all controllable consumers.

FIG. 2 shows a table containing command information SZ which is transmitted as a real-time signal S for achieving an existing activation state Z, various binary-coded command information SZ being illustrated in the first column, and a change in activation state Z being illustrated in the second column. A “+” sign denotes switching on, and a “−” sign denotes switching off, of corresponding relay KA, KH or of corresponding relay windings EW, HW of meshing relay ES. This command information SZ thus represents instructions of controller 3 to actuating device 4 for setting a certain activation state Z, in each case an individual consumer to be controlled being switched by an instruction. Binary-coded command information SZ may also be associated with any other given activation state Z.

In one alternative preferred exemplary embodiment, as previously mentioned, as command information SZ a four-digit, binary-coded command information SZ is transmitted as real-time signal S, which defines one certain activation state of the 64 possible activation states Z. It is preferred that the individual bits of four-digit binary command information SZ are each assigned to exactly one relay KA, KH or one winding EW, HW, and in each case indicate whether these relays or windings are switched on, i.e., energized, or switched off during activation state Z to be achieved. For such command information SZ it is advantageous that activation state Z to be achieved is completely described in each case by command information SZ, i.e., is settable in a defined manner, regardless of a prior activation state Z.

It is also preferred that real-time signal S is used not only to transmit command information SZ for achieving certain activation states Z, but also for achieving additional states, for example for an emergency stop or for an emergency start, or that safety information is transmitted as real-time signal S.

The top half of FIG. 3 shows a time-rotational speed characteristic curve diagram, and the bottom half shows corresponding activation states Z during operation of system 1 for starting internal combustion engine 2. Internal combustion engine 2 is operated in a start-stop operating mode; at the start of time axis t, internal combustion engine 2 is switched off and at a standstill after it has been switched off and has come to a rest as the result of stopping the motor vehicle according to a start-stop operating strategy. A rotational speed n₁₆ of annular gear 16 which corresponds to a rotational speed of internal combustion engine 2 is plotted in the top half. For activation states Z shown, in particular as explained previously or below, actuating device 4 is addressed by controller 3 via real-time interface and/or data interface 6, 8, respectively.

Along time axis t, internal combustion engine 2 is thus at a standstill before the starting operation begins, so that rotational speed n₁₆ is zero. With the aid of actuating device 4, an activation state Z is switched in which all relays KA, KH, ES are switched off. For starting, at a point in time t₁ controller 3 transmits a real-time signal S having command information SZ “001,” and immediately thereafter transmits another real-time signal S having command information SZ “011,” to actuating device 4 in order to switch on pull-in winding EW and holding winding HW according to FIG. 2. Meshing relay ES is thus energized at maximum power in order to couple internal combustion engine 2 to starter motor 17, in particular, by starter pinion 15 meshing with annular gear 16.

A real-time signal S having command information SZ “000” is subsequently transmitted at a point in time t₂ in order to switch off pull-in winding EW and to keep starter pinion 15 meshed with annular gear 16 at a reduced power consumption of meshing relay ES. Immediately thereafter, another real-time signal S having command information SZ “101” is transmitted from controller 3 to actuating device 4 in order to switch on starter relay KA and to crank starter motor 17 with a reduced starting current via starting resistor 18 in such a way that an undesirably high voltage dip is prevented.

At a point in time t₃, rotational speed n₁₆ has reached a rotational speed n₁ that is different from zero, so that due to the rotary motion a voltage is induced in starter motor 17 which counteracts a voltage dip, so that starter motor 17 may be subsequently operated at full electrical power without disadvantage. For this purpose, a real-time signal S having command information SZ “111” is transmitted at point in time t₃ in order to switch on holding relay KH and energize starter motor 17 directly from battery 21. Immediately thereafter, another real-time signal S having command information SZ “100” is transmitted in order to switch off starter relay KA. Internal combustion engine 2 is subsequently driven with full electrical power of starter motor 17 until a further rotational speed n₂ is reached at which internal combustion engine 2 runs on its own.

After internal combustion engine 2 has been started in this way, a real-time signal S having command information SZ “110” is transmitted from controller 3 to actuating device 4 at a point in time t₄ in order to switch off holding relay KH, so that starter motor 17 is switched off again. A real-time signal S having command information SZ “010” is subsequently transmitted at a point in time t₅ in order to switch off holding winding HW of meshing relay ES and to unmesh starter pinion 15 from annular gear 16.

FIG. 4 shows a particular process sequence of a start-stop operating mode in which a start request to internal combustion engine 2 occurs during coasting of internal combustion engine 2 due to a prior stop signal. The start request occurs after internal combustion engine 2 no longer has a speed for self-starting, so that it must be started externally by starter device 100. This process sequence is illustrated in the top half as a time-rotational speed characteristic curve in which a rotational speed n is plotted with respect to time axis t. As previously mentioned, due to the stop signal, running internal combustion engine 2 is switched off at a switch-off point in time t_{A} by interrupting a fuel supply, so that, beginning at switch-off point in time t_{A}, internal combustion engine 2 coasts at a progressively decreasing rotational speed. This rotational speed progression is illustrated via rotational speed n₁₆ of annular gear 16.

To increase the availability of internal combustion engine 2 in the start-stop operating mode, i.e., to allow switched-off, coasting internal combustion engine 2 to be restarted during the coasting, starter pinion 15 is meshed with rotating annular gear 16. For this purpose, a defined and precisely specified control of starter motor 17 and of relays KA, KH, ES is important for a low-wear or wear-free coupling with the internal combustion engine.

For this purpose, at a point in time t₁ control device 4 transmits a real-time signal S having command information SZ “101” in order to switch on starter relay KA and energize starter motor 17 via starting resistor 18. Starter motor 17 is thus accelerated, at reduced electrical power, to a rotational speed n₁₅ of starter pinion 15 which is higher than a rotational speed n₁₅ at an intended subsequent coupling point in time. Starter motor 17 is subsequently switched off with the aid of a real-time signal S having command information SZ “100,” so that the starter motor coasts at a decreasing rotational speed n₁₅.

As soon as starter pinion 15 and annular gear 16 have reached generally synchronous rotational speeds, starter pinion 15 is meshed with annular gear 16 in a low-wear or wear-free manner, in that at a point in time t₃, with the aid of real-time signal S having command information SZ “001” and another real-time signal S, following immediately thereafter, having command information SZ “011,” meshing relay ES is energized at maximum power as previously described. Starter motor 17 and internal combustion engine 2 are thus coupled, so that a real-time signal S having command information SZ “000” for switching off pull-in winding EW is transmitted at a point in time t₄, and immediately thereafter a real-time signal S having command information SZ “101” for switching starter relay KA is transmitted. For reducing a voltage dip, starter motor 17 is energized with reduced power via starting resistor 18 in order to crank internal combustion engine 2 which is coupled thereto.

A real-time signal S having command information SZ “111,” followed immediately by a real-time signal S having command information SZ “100,” is transmitted at a point in time t₅ in order to energize the starter motor for full electrical power via holding relay KH instead of via starter relay KA, and to crank internal combustion engine 2 at maximum power. As soon as internal combustion engine 2 is running on its own, a real-time signal S having command information SZ “110” is transmitted at a point in time t₆ in order to terminate the energization of starter motor 17 by switching off holding relay KH. Subsequently, meshing relay ES is also switched off at a point in time t₇ with the aid of a real-time signal S having command information SZ “010” in order to decouple starter motor 17 and internal combustion engine 2.

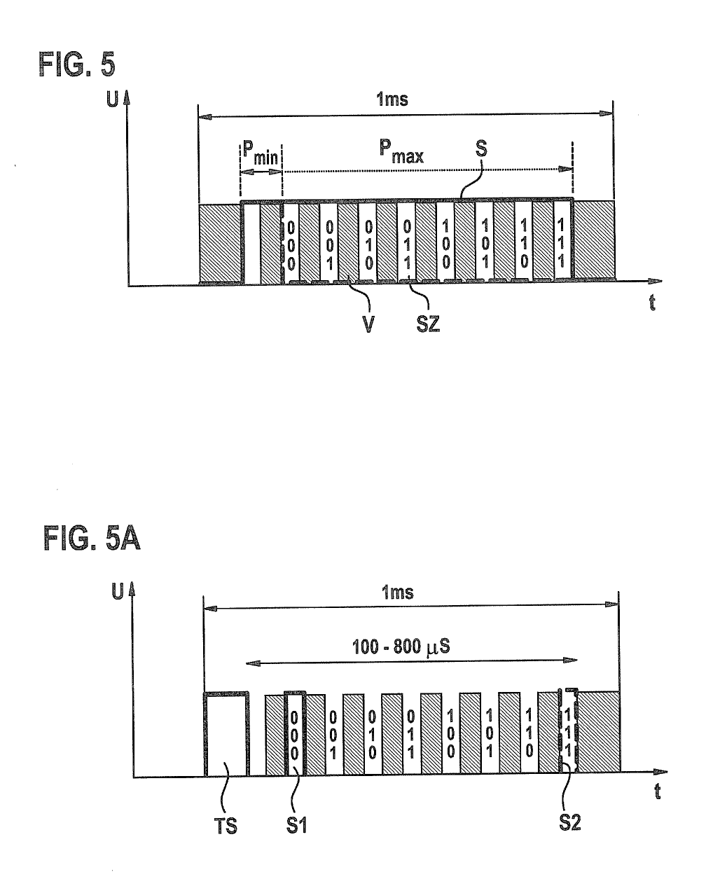

FIG. 5 schematically shows a time and voltage diagram having information coding during operation of system 1, using a pulse width-modulated real-time signal S, a voltage U of real-time signal S being plotted with respect to time axis t. In this method, command information SZ is pulse width-coded, i.e., coded over a length of real-time signal S, the length of a pulse being incrementally varied between a minimum value Pₘᵢₙ for command information SZ “000” and a maximum value Pₘₐₓ for command information SZ “111.”

To ensure reliable transmission, i.e., reliable information communication and interpretation, of real-time signal S, the transmitter and receiver, i.e., real-time interfaces 6 of controller 3 and of actuating device 4, preferably have at least twice the operating frequency of real-time signal S. Real-time interfaces 6 therefore operate in a 25-microsecond clock pulse, for example, real-time signal S being transmitted in a 1-millisecond clock pulse, for example, so that a certain length of the pulse is reliably generated or recognized. The length of the pulses themselves varies between minimum value Pₘᵢₙ of 100 microseconds and maximum value Pₘₐₓ of 900 microseconds. Real-time signal S is thus transmitted within a precisely predictable time period of the 1-millisecond clock pulse, so that command information SZ is transmitted in real time. A delay due to the 1-millisecond clock pulse of real-time signal S corresponds to the operating cycle of controller 3 and of actuating device 4, so that the delay does not affect an operating process of system 1. Incidentally, the transmission of real-time signal S is faster than the transmission of data information via data communication device 9, illustrated in FIG. 12d, which also is not predictable with great accuracy.

To increase the transmission security of real-time signal S, prohibited length ranges V between permitted ranges are preferably defined for the length of the pulses, which separate the permitted lengths of the pulses from one another according to the coding of command information SZ. It is also preferred that for increasing the transmission security in a prohibited range V, in particular in a time range between an end of the pulse and the start of a subsequent 1-millisecond clock pulse, check information, for example as a check bit (“parity bit”), is transmitted.

The volume of information to be coded increases and decreases, depending on the number of possible activation states Z or the various provided command information items SZ, so that, for example, a signal frequency is increased or decreased. In one alternative method, for reducing the volume of information to be transmitted via real-time signal S, data information is already transmitted via data interfaces 8 and data communication means 9 prior to real-time signal S.

In one preferred method, information for switching on or switching off the particular relay KA, KH or windings EW, HW determined by the pulse width coding is transmitted via an algebraic sign of voltage U, i.e., via a polarity. A switch-on signal is preferably determined by a positive voltage U, and a switch-off signal is preferably determined by a negative voltage U.

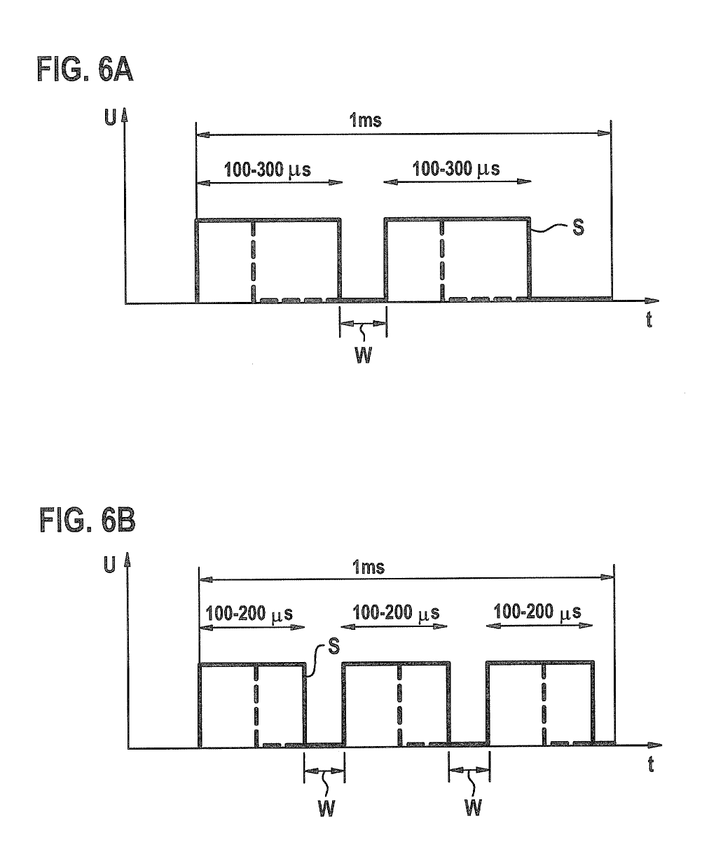

FIG. 6 schematically shows further information coding during operation of system 1, which differs from that shown in FIG. 5 in that a plurality of pulses per 1-millisecond clock pulse is transmitted as real-time signal S, command information SZ also being coded by a number of the pulses per 1-millisecond clock pulse. Command information SZ of real-time signal S is preferably transmitted via pulse width-coding as well as via coding by the number of pulses. As illustrated in FIG. 6 and in FIG. 6 as an example, various combinations of length and number of pulses are preferred, depending on the volume of information to be coded. In addition, the individual pulses are spaced apart from one another with regard to time, preferably by a certain pulse interval W, in order to increase security for a correct information transmission and interpretation. Furthermore, coding of real-time signal S via the length and number of pulses is adaptable in a particularly flexible manner, in particular with regard to a different number of possible command information items SZ.

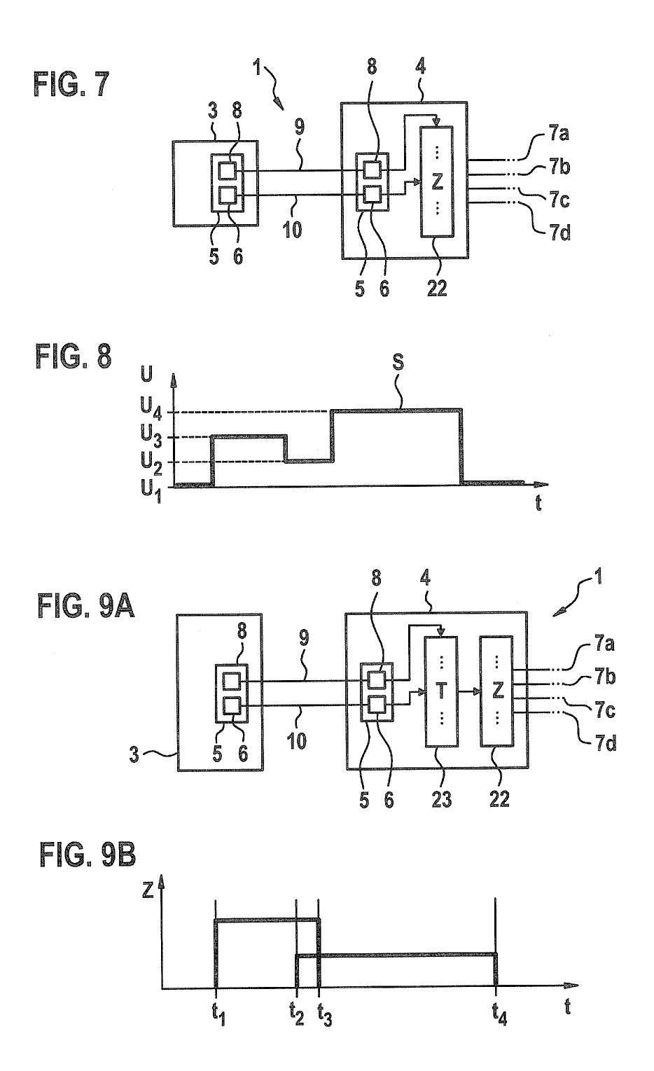

FIG. 7 shows a circuit diagram of a preferred system 1 which differs from that shown in FIG. 1, in that a state machine 22 is stored in actuating device 4, state machine 22 being defined for a certain sequence of activation states Z.

In one preferred method for operating this system 1, state machine 22 is cycled through with the aid of real-time signal S which is transmitted from controller 3 to actuating device 4 via real-time interfaces 6 and real-time communication device 10; i.e., state machine 22 in each case switches an activation state Z, which subsequently follows according to the sequence of activation states Z, through a sequence of real-time signals S. Thus, only one starting pulse needs to be transmitted as command information SZ for a transition to state machine 22, for example as a voltage edge of real-time signal S which triggers state machine 22.

One possible disadvantage of a state machine 22 is that in the event of error, controller 3 has no information concerning an actual control. It is therefore preferred that a model of state machine 22 is stored in controller 3 and is appropriately carried along in parallel during the through-cycling, so that information concerning the particular state of state machine 22 is available in controller 3.

In addition, in one preferred system 1, state machine 22 has the simplest technical design possible as a fixed, predetermined state machine 22 having little complexity of components. One disadvantage of such a state machine 22 is that controller 3 has no ability to influence the sequence of activation states Z. For this reason, it is alternatively preferred that the state machine as illustrated in FIG. 7 has a configurable design. In one preferred method, a certain sequence of activation states Z is transmitted as data information, prior to a real-time signal S, from controller 3 to actuating device 4 via data interfaces 8, and stored in state machine 22. State machine 22 is easily and flexibly variable in this way.

In addition, it is preferred that a certain sequence element of the sequence of activation states Z represented by state machine 22 is predetermined via data interfaces 8, and subsequently switched on for a precisely timed switching operation, using real-time signal S as a trigger signal of activation state Z corresponding to this sequence element. The sequence of activation states Z may thus be started at any arbitrary point in order to control certain sequences or subsequences of the sequence.

FIG. 8 schematically shows a time and voltage diagram having information coding of a real-time signal S in one preferred method for operating system 1, in which a certain command information SZ is transmitted via a voltage-coded real-time signal S. In FIG. 8, real-time signal S is plotted as the progression of voltage U with respect to time axis t, in this case four command information items SZ, coded with the aid of different voltage levels U₁ through U₄ in a temporal sequence, being transmitted as real-time signal S. An additional volume of information may thus be added to real-time signal S with the aid of voltage U, and in particular without further time delay in the transmission. In one alternative method, real-time signal S also accepts negative voltages U, for example to code additional activation states Z.

It is preferred that a certain activation state Z is controlled, i.e., switched on and off, by voltage levels U₁ through U₄ at a point in time of an edge of real-time signal S. Very short switching times, which are determined essentially by the switching times of the components of real-time interfaces 6, may thus be achieved.

In one alternative method it is preferred that a command information SZ which is transmitted as a pulse width-modulated real-time signal, in particular according to FIG. 5, is additionally coded via voltage levels U₁ through U₄, in particular preferably via the algebraic sign of the voltage, for switching on and switching off an activation state Z or a particular relay according to the table in FIG. 2. The pulse width coding according to FIG. 5 may thus be reduced by at least one bit of information volume in order to achieve shorter transmission times of real-time signal S.

FIG. 9a shows a circuit diagram of a preferred system 1 which differs from that illustrated in FIG. 7 in that actuating device 4 includes a timer 23 for controlling state machine 22. A fixed, predetermined sequence of activation states Z is stored in state machine 22, and a certain time interval having associated control periods T is preferably stored in timer 23.

In one method for operating this system 1, in a first step controller 3 transmits to timer 23 the time interval, i.e., control periods T, as data information via data interfaces 8. For the most precisely timed switching possible of the particular activation states Z, timer 23 is started by real-time signal S, causing the timer to trigger state machine 22 in a precisely timed manner in a time sequence according to the time interval, in each case after the particular control periods T, and in particular without any delay due to the coupling between controller 3 and actuating device 4. Thus, with the aid of a real-time signal S as a start signal, the sequence of activation states Z stored in state machine 22 corresponding to control periods T stored in timer 23 is automatically controlled with high temporal accuracy by actuating device 4.

In an alternative preferred system 1, control device 4 is provided with a state machine 22 which is designed for the certain sequence of activation states Z and preferably also for associated control periods T, thus saving separate timer 23.

FIG. 9b shows a diagram of one example of a variation of activation states Z over time along time axis t, during control of a system 1 according to FIG. 9A. Prior to a point in time t₁, the sequence of control periods T is transmitted to timer 23 as data information via data interfaces 8, and a real-time signal S for starting timer 23 is transmitted at point in time t₁. Actuating device 4 subsequently automatically controls activation states Z determined by the sequence corresponding to control periods T in a precisely timed manner, as follows: starter relay KA is switched on at point in time t₁, holding relay KH is subsequently additionally switched on at point in time t₂, starter relay KA is switched off at point in time t₃, and lastly, holding relay KH is also switched off at point in time t₄. Points in time t₂ through t₄ result from the stored sequence of control periods T.

A complete sequence is preferably stored as a control sequence, or alternatively, preferably only a suitable subsequence is stored as a subsequence, in control device 4, and controller 3 starts a control according to this sequence with the aid of a real-time signal S. Actuating device 4, in particular timer 23 and state machine 22, is/are preferably designed in such a way that a control already running according to such a sequence is also terminated in real time by a real-time signal S as the switch-off signal.

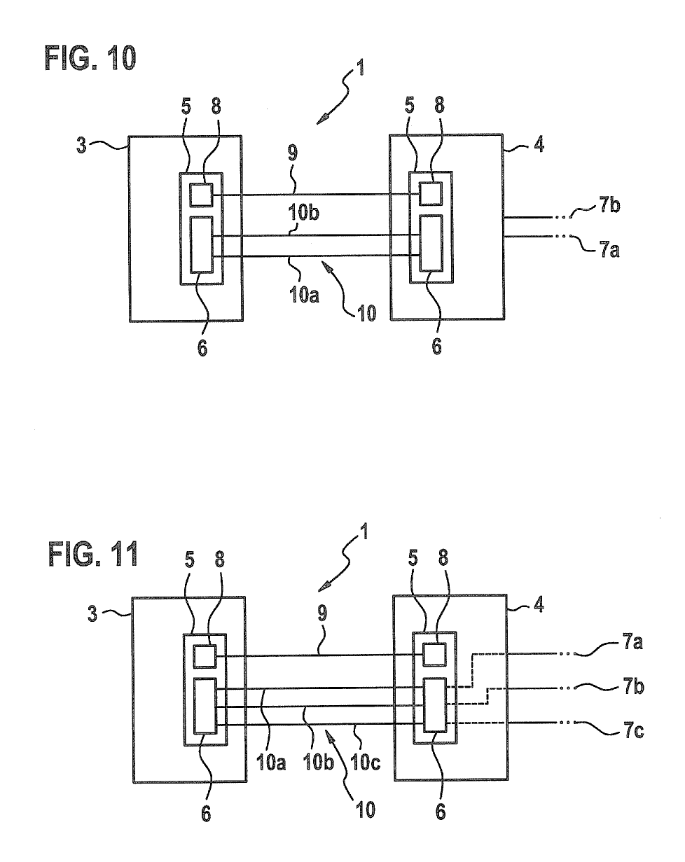

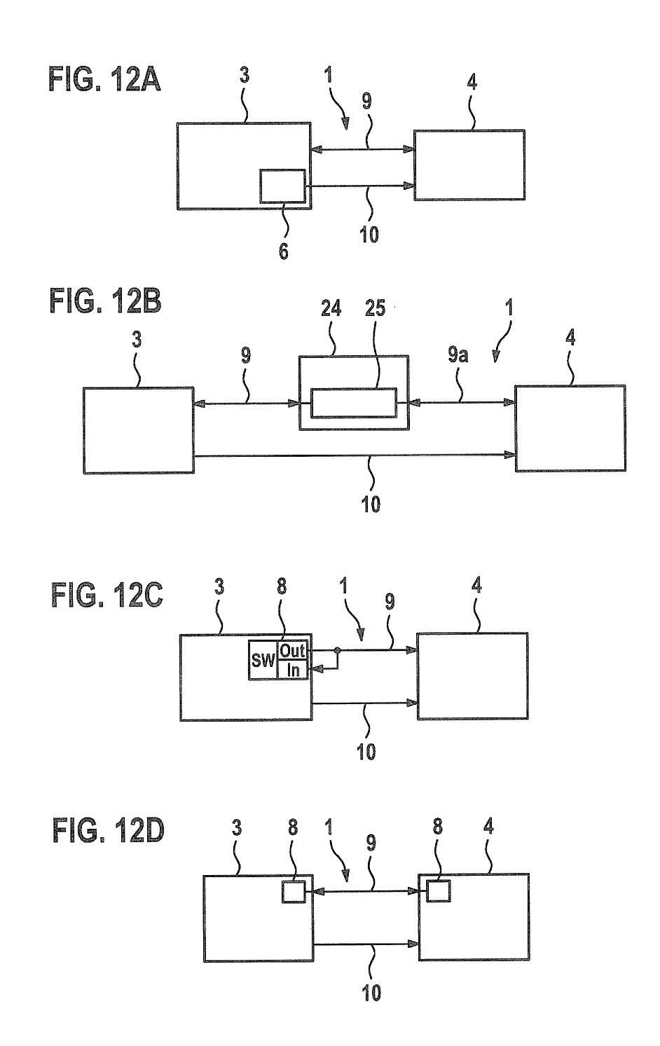

FIG. 10 shows a circuit diagram of a preferred system 1 which differs from that shown in FIG. 1a in that real-time communication device 10 has a plurality, in the present case two, for example, of parallel communication lines 10a, 10b, command information SZ being transmitted in parallel in bit-coded form via parallel communication lines 10a, 10b in order to achieve a certain activation state Z. In this exemplary embodiment, a total of four different command information items SZ may thus be correspondingly transmitted in bit-coded form via the two parallel communication lines 10a, 10b; i.e., two control lines 7a, 7b may be controlled independently of one another.

In one alternative exemplary embodiment, real-time communication means 10 includes more than two parallel communication lines 10a, 10b, so that a larger number of different command information items SZ, i.e., a higher volume of information, is correspondingly transmittable as a real-time signal.

In addition, in one alternative example, interface device 5 or controller 3 and/or actuating device 4 is/are provided with a plurality of individual real-time interfaces 6 corresponding to the number of parallel communication lines 10a, 10b.

FIG. 11 shows a circuit diagram of a preferred system 1 which differs from that illustrated in FIG. 1a in that meshing relay ES is provided with a single coil, and for each control line 7a, 7b, 7c to be controlled, i.e., for each relay KA, KH, ES to be controlled, a separate communication line 10a, 10b, 10c, in each case connected in parallel, of real-time communication means 10 is provided, in each case only associated control line 7a, 7b, 7c being switched on or off with the aid of a separate real-time signal S via a certain communication line 10a, 10b, 10c. Additional complexity for the coding of a certain command information SZ is thus avoided, and in addition the time required for the coding or the transmission of the coded command information SZ is spared, so that higher accuracy is achieved in the control. In addition, a high level of control reliability is thus achieved.

These advantages also result when, in one alternative exemplary embodiment, a command information SZ is transmitted as an individual real-time signal S via parallel communication lines 10a, 10b, 10c, each relay KA, KH, ES to be controlled being controlled separately by an individual communication line 10a, 10b, 10c.

FIG. 12a shows a circuit diagram of a preferred system 1 which differs from that illustrated in FIG. 1a in that real-time interface 6 of controller 3 is designed as an interface to a timer, in particular a GPTA® which is connected to ground, for example with the aid of a so-called low-side output stage.

The general purpose timer array (GPTA®) is a microcontroller peripheral component having specialized functions for PWM signal generation and for measuring input signals (input capture). The GPTA® includes multiple function cells which may be flexibly wired to one another to produce complex and rapid output pulse samples. Rapid, complex PWM samples, which repeat and change and which have a high resolution and short period times, may be generated using the function of a GPTA®. If a microcontroller is used for control unit 3, either a correspondingly complex and rapid real-time signal S is obtainable only by using the GPTA®, or the computing power requirements imposed on the microcontroller for generating complex real-time signal S are significantly reduced.

FIG. 12b shows a circuit diagram of a preferred system 1 which differs from that illustrated in FIG. 1a in that controller 3 and actuating device 4 are coupled to one another only indirectly by data communication means 9, for example a central computer 24 having a networking device 25, a so-called gateway, being connected in-between. A controller 3 and an actuating device 4 having different data interfaces 8 which in particular are designed for different data communication means 9, 9a may thus be connected to one another, in that networking device 25 makes an appropriate interface conversion. Thus, data communication means 9 is preferably designed as a so-called CAN bus, and data communication means 9a is preferably designed as a so-called LIN bus.

FIG. 12c shows a circuit diagram of a preferred system 1 which differs from that illustrated in FIG. 1a in that controller 3 is provided by a data interface 8 having a simplified circuitry, a LIN bus interface being emulated by a switching device, connected to ground, for small electrical outputs as a “LIN transmitter,” and a digital input stage being emulated as a “LIN receiver.” Controller 3 may be manufactured more cost-effectively in this way.

FIG. 12d shows a circuit diagram of a preferred system 1 according to FIG. 1 in which data communication device 9 is designed as a bidirectional 1-bit bus, and in particular as a LIN bus. In one alternative preferred system 1, data communication means 9 is designed as a CAN bus or a bidirectional 1-bit-interface according to ISO 9141, also referred to as a K line. Accordingly, the particular data interfaces 8 then also have a compatible design. All figures show illustrations which are strictly schematic and not to scale.

1-11. (canceled)

12. A method for operating a system, comprising:
transmitting in the system a real-time signal for achieving an activation state of an actuating device from a controller to the actuating device via a real-time communication device with the aid of real-time interfaces; and
transmitting command information which determines one of the activation state or a change in the activation state together with the real-time signal so that electrical consumers are controlled by the actuating device independently of one another.

13. The method as recited in claim 12, further comprising:
in response to the command information, at least one of: i) switching on or off a certain activation state for a given control period, ii) starting an activation state which subsequently follows according to a certain sequence of activation states, and iii) starting the certain sequence of activation states including a certain time interval of the activation states.

14. The method as recited in claim 12, wherein the actuating device and the controller each have a data interface which is different from the real-time interface and via which data information is transmitted with the aid of a data communication device, and prior to the real-time signal with respect to time, the controller transmitting data information to the actuating device via the data communication device, the data information determining at least one of: i) an activation state, ii) a change in the activation state, iii) a control period, iv) a sequence of activation states, and v) a time interval for the sequence of activation states.

15. The method as recited in claim 12, wherein the real-time signal transmits command information which is pulse width-coded.

16. The method as recited in claim 12, wherein the real-time signal transmits command information in voltage-coded form.

17. The method as recited in claim 12, wherein the real-time signal transmits command information in coded form as an algebraic sign of an electrical voltage of the real-time signal for switching an activation state on or off.

18. The method as recited in claim 12, wherein the real-time signal transmits, in parallel, command information that is bit-coded with the aid of the real-time interfaces and a plurality of parallel communication lines of the real-time communication device, the plurality corresponding to a number of switching devices.

19. A method as recited in claim 12, wherein the system includes a starter device for starting an internal combustion engine of a motor vehicle.

20. An interface for a controller or an actuating device of a starter device of a motor vehicle for starting an internal combustion engine, the interface device having a real-time interface which is configured to transmit a real-time signal from the controller to the actuating device via a real-time communication device to achieve an activation state of the actuating device, the interface device including a data interface, which is different from the real-time interface, for a data communication device to which the controller and the actuating device are coupleable, and wherein command information which determines one of the activation state or a change in the activation state is transmittable together with the real-time signal so that electrical consumers are controllable by the actuating device independently of one another.

21. A starter device for an internal combustion engine for a motor vehicle having a system which includes a controller and an actuating device which are each coupled with the aid of real-time interfaces via a real-time communication device for transmitting a real-time signal, the real-time signal to achieve an activation state of the actuating device being transmittable from the controller to the actuating device, the controller and the actuating device each having a data interface which is different from the real-time interface and via which they are coupled to a data communication device and wherein a command information which determines the activation state or a change in the activation state is transmittable together with the real-time signal so that electrical consumers are controllable by the actuating device independently of one another.

22. A computer readable medium storing program instructions for operating a system, the program instruction when executed by a controller or actuating device, causing a system to perform the steps of:
transmitting in the system a real-time signal for achieving an activation state of an actuating device from a controller to an actuating device via a real-time communication device with the aid of real-time interfaces; and
transmitting command information which determines the activation state or a change in the activation state together with the real-time signal so that electrical consumers are controlled by the actuating device independently of one another.
